(19) United States
(12) Patent Application Publication
(10) Pub. No.: US 2016/0110551 A1
(43) Pub. Date: Apr. 21, 2016

(54) Computer System Anomaly Detection Using Human Responses to Ambient Representations of Hidden Computing System and Process Metadata

(71) Applicant: THE UNITED STATES OF AMERICA AS REPRESENTED BY THE SECRETARY OF THE NAVY, SAN DIEGO, CA (US)

(72) Inventors: Sunny J. FUGATE, SAN DIEGO, CA (US); Jamie R. LUKOS, SAN DIEGO, CA (US); Robert S. GUTZWILLER, SAN DIEGO, CA (US); Karl P. WIEGAND, SAN DIEGO, CA (US)

(73) Assignee: THE UNITED STATES OF AMERICA AS REPRESENTED BY THE SECRETARY OF THE NAVY, SAN DIEGO, CA (US)

(21) Appl. No.: 14/976,225

(22) Filed: Dec. 21, 2015

Related U.S. Application Data
(63) Continuation-in-part of application No. 13/767,131, filed on Feb. 14, 2013, now Pat. No. 9,229,619.

(51) Int. Cl. G06F 21/57; G06F 21/55

(52) U.S. Cl. CPC G06F 21/577; G06F 21/552; G06F 2221/034

(57) ABSTRACT

A system and method involve measuring one or more hidden states internal to a computing system related only to a user's active task with the computing system, using one or more deterministic mapping functions to directly map, without interpretation of the hidden states as being benign or malicious, the measurements to a representational output, presenting the representational output in real-time and peripheral to the user's active task with the computing system without label information pertaining to the hidden states, determining the user's behavioral responses and/or physiological responses to the presented representational output, altering one or more display characteristics of the presented representational output based upon one or more behavioral responses and physiological responses, and/or inputting the user's response into a machine learning algorithm configured to detect an anomaly within the computing system using the user's behavioral and physiological responses and/or computing system measurements.

### CROSS-REFERENCE TO RELATED APPLICATIONS

This application is a continuation-in-part of commonly-assigned U.S. patent application Ser. No. 13/767,131 filed Feb. 14, 2013, entitled “Ambient Activity Monitors for Hidden Computing System and Process Metadata”, the content of which is fully incorporated by reference herein.

### FEDERALLY-SPONSORED RESEARCH AND DEVELOPMENT

This invention is assigned to the United States Government and is available for licensing for commercial purposes. Licensing and technical inquiries may be directed to the Office of Research and Technical Applications, Space and Naval Warfare Systems Center, Pacific, Code 72120, San Diego, Calif., 92152; phone (619)553-5118; email ssc_pac_T2@navy.mil; reference Navy Case Number 103911.

### BACKGROUND

Viruses, malicious code, and other computer threats are rapidly evolving and are becoming more difficult to detect. Automated mechanisms to ensure safety are also evolving, but existing detection methods commonly detect what has already happened. Anti-virus software detects the post-mortem infection of a system. An intrusion detection system identifies events which have already occurred. Such systems are generally unable to prevent other situations that rely on human culpability. Often the first and last defenses are decisions made by the computer user.

Sophisticated methods are often used to fool users into making precisely the decisions necessary for system exploitation to occur. Even though threats to computing systems have become progressively more adept at exploiting human users, little work has been performed in providing human users with better information for decision making regarding computer security. Much of this threat relies on the user lacking sufficient information regarding system state. A need exists for an improved system and method that can assist in detecting changes in the state of a computing system.

### BRIEF DESCRIPTION OF THE DRAWINGS

FIG. 1 shows a block diagram of an embodiment of a system that may be used to perform the methods in accordance with the Computer System Anomaly Detection Using Human Responses to Ambient Representations of Hidden Computing System and Process Metadata.

FIG. 2 shows a process flowchart of an embodiment of a feed-forward ambient activity monitor method using human measurements.

FIG. 3 shows a process flowchart of an embodiment of a feed-forward ambient activity monitor method using both human and computing system measurements for anomaly detection.

FIG. 4 shows a process flowchart of an embodiment of a method using anomaly detection algorithms using measurements from the computing system, human perception and decisions, and sensor measurements of human behavior and physiology.

FIG. 5 shows a process flowchart of an embodiment of a method for anomaly detection using measurements from a plurality of computing systems and human users.

FIG. 6 shows a process flowchart of an embodiment of a method using human measurements to modify system behavior and calibrate visualization mapping functions.

FIG. 7 shows an embodiment of a computing system that may be used to perform the methods disclosed herein.

FIG. 8 shows a flowchart of an embodiment of a method in accordance with the Computer System Anomaly Detection Using Human Responses to Ambient Representations of Hidden Computing System and Process Metadata.

FIGS. 9A-9C show diagrams illustrating the alteration of an operating system level and software application level representational output presented to a user responsive to the user's response to the initially presented representational output.

### DETAILED DESCRIPTION OF SOME EMBODIMENTS

Reference in the specification to “one embodiment” or to “an embodiment” means that a particular element, feature, structure, or characteristic described in connection with the embodiments is included in at least one embodiment. The appearances of the phrases “in one embodiment”, “in some embodiments”, and “in other embodiments” in various places in the specification are not necessarily all referring to the same embodiment or the same set of embodiments.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

Additionally, use of the “a” or “an” are employed to describe elements and components of the embodiments herein. This is done merely for convenience and to give a general sense of the invention. This detailed description should be read to include one or at least one and the singular also includes the plural unless it is obviously meant otherwise.

The term “module” generally refers to a software module. A module may be implemented as a collection of routines and data structures that performs particular tasks or implements a particular abstract data type. Modules generally are composed of two parts. First, a software module may list the constants, data types, variables, and routines that may be accessed by other modules or routines. Second, a module may be configured as an implementation, which may be private (i.e., accessible only to the module), and which contains the source code that actually implements the routines or subroutines upon which the module is based. Thus, the use of the term “module” herein, indicates reference to such software modules or implementations thereof. The terms “module” and “software module” can be utilized interchangeably with one another to describe the same element or feature.

Disclosed herein are embodiments of a system/method that provide comprehensive supplemental peripheral information concerning software and operating system states so that a human user can better perceive, predict, and adapt to emerging threats to their computing environment.

The embodiments apply the theory of “ambient” or “peripheral” information displays to the display of real-time system and process metadata such that the displayed information can be used as event predictors (of threats) by a human computer user while not demanding user attention. The basic concept is that the user is better able to predict threats when supplemental information about the “computing environment” is peripherally available. The ambient information display is non-obtrusive and provides predictable visual, auditory, and kinesthetic cues that relate to the flow of information within and between computing systems.

In some of the disclosed embodiments, the computing system determines the response necessary based on the data available and either presents a decision to the user regarding the anomaly or takes automated action to correct the anomaly. In some embodiments, the computing system may still perform automated decision making and decision support, but additionally, the computing system shows representations of underlying data to a user in an ambient representation and lets the user decide on whether the current form of the representation is an anomaly or expected behavior.

These embodiments are further expanded through the method of taking direct measurements of a human user's response in the form of behavioral, psychological, and physiological characteristics and subsequently feeding these measurements back into the computing system or into a separate computing system for purposes of learning how the human user responds to changes in the computing system. Using these human physiological, psychological, and behavioral measurements the computing system can be programmed to detect both conscious and subconscious responses in order to determine whether and how a user is responding to the ambient information being displayed. Furthermore, displayed information is not limited to computer system information and could also include physiological measures. For instance, if information regarding the user's physiological state and recent behaviors is indicative of changes in computer internal state (e.g., slower human response times due to above normal computer processing times), then the user's own meta data may be used as part of the peripheral display.

Conventional methods of displaying real-time computing-system-state generally demand primacy within the display environment. Even in the real-time case the information provided within conventional displays is generally superficial and their display often occurs only after nefarious events (e.g. process usage increases after it has been exploited). The embodiments disclosed herein provide a method and apparatus for providing peripheral information regarding the live state of a computing machine at all times (not just when an issue occurs). The disclosed embodiments provide a direct representation of the underlying machine states so that they may learned and associated with user and system behaviors and so that they can be used as predictive cues by a human operator. The embodiments do not interpret the hidden states as being benign or malicious, but present a direct mapping of hidden states into a representation suitable for display in an ambient fashion.

It should be recognized that the embodiments are not limited to computer security applications. Hidden system information can also be represented in order to provide a user with cues regarding relevant internal states of the machine such as whether a process is underway or completed, updates on its active state, and whether there is unexpected contention for system resources.

Further, the embodiments do not limit the scope of what can be displayed to solely those data or metadata that have a clear semantics. As long as the relationship between state of the machine and the visual, auditory, or kinesthetic display are predictable (i.e. deterministic) then inferred associations can be learned by a human operator. Nonetheless, it is clear that more sophisticated displays can be constructed through the use of natural language processing in combination with event monitoring, state analysis, protocol analysis, and process analysis. These displays should be constructed to provide a peripheral context for the active computing environment, and that providing a peripheral context will enable better decisions regarding threat. The resulting ambient activity monitor (AAM) should optimally produce displayed representations in real-time as hidden states change.

The AAM processes data and metadata from various operating system and software components and produces perceptually appealing “projection” or mapping (e.g. visual, auditory, tactile, and kinesthetic) of these data into one of several associated display regions. Generally, this data represents the internal latent and active state of the software and hardware of the computing system.

For example, the data processed by each AAM may represent the state of the computing device or actively running software or process. The “projection” of the data is performed such that it lies to the periphery of the human perceptual system. In this way, hidden system and process metadata is displayed in a way that is unobtrusive, but allows the human perceptual system to learn associations between the AAM and their actions within the computing environment. Deviations from perceptual expectations can then be detected by the human computer operator as perceptual cues which could be acted on directly by a human user. In this way, behavioral modifications based on these cues may prevent, acknowledge, or otherwise act on new and emerging threats (or emerging changes to the underlying computer system which are relevant to the active tasks).

This approach differs significantly from other software instrumentation and security visualization systems (which are exclusively used in a primary display mode) or with existing peripheral display systems (e.g. Mac OS X Dashboard) which display labeled information such as weather or stock prices. The data processed by the AAMs are not information retrieved from online or local information resources for the purposes of “information awareness”, but are the current hidden states internal to a computing machine, its computations, and its communication.

AAMs do not display clearly labeled information, but graphical, auditory, haptic, and kinesthetic “graphics” which are associated with and derived from user and system actions and interactions. If taken out of context of an operating system or software application the AAM would lose its meaning and appear only as abstract (although perhaps still pleasing) shapes, sounds, touch, or movement. Conventional peripheral “information displays” contain informative icons and numeric values and can be easily understood in any context (e.g. a stock histogram, a current weather display using icons, a news ticker, a conventional software process monitor, etc.).

The semantics of each AAM are inferred over time and experience by a human operator (e.g. If I go to website X then this pattern appears next to my browser window. If I am led to the wrong website, the pattern is novel and unexpected.). The display of an AAM is carefully designed to be deterministic and predictable and represents a functional mapping between the state of the computing system and the display.

The AAM may also be constructed to either accentuate or diminish small differences in the data depending on the intent of the AAM designer. In a diminishing mode the same or similar set of input data may produce similar displayed forms. It should be understood that in order to produce a graphical display which is similar for similar data, that the mapping functions between input data and the AAM will often be mathematically smooth. In an accentuation mode the same or similar set of input data may produce wildly different displayed forms. Depending upon the input data, there may also be mapping functions which introduce large discrete changes for small changes in input data. This would be desired in some instances in order to accentuate and disambiguate data that are mathematically adjacent or are members of an enumerated set (e.g. computer internet protocol ports, similar website domain names).

Each running AAM may operate concurrently in one or more modes which are associated with different views of the computing system hardware, operating system, and software. A computing system hardware mode may represent information in association with the physical hardware of a computing system. A computing system AAM may represent data flows related to the physical hardware such as voltage variations of electrical connections, the transfer of raw data on a system bus, the usage of physical ports such as Ethernet and Universal Serial Bus, the real-time temperatures of embedded micro-controllers, or the physical usage characteristics of video or system memory.

An operating system mode may be attached to and sit visually or temporally adjacent to the primary view of an operating system (e.g. Microsoft Windows, Apple Mac OS, Linux). The operating system AAM may represent system-wide memory management and swap space characteristics, process scheduling, interrupt requests, network stack and packet characteristics, or other aspects of the operating system which are traditionally hidden.

A software application mode may sit visually or temporally adjacent to a particular application window (or multiple windows belonging to the same application). A software application AAM may represent the various files open by the application; the actual content of an open file; system or function call traces; process and child thread scheduling characteristics; I/O blocking, waiting, write, and read characteristics; network application layer session characteristics; memory reads and writes; and other aspects of a software application which are traditionally hidden. A daemon mode may sit visually adjacent to and subtended to the AAM of a parent process (i.e. to an operating system mode AAM or a software application mode AAM).

Further, the AAM need not be pure in respect to which mode of operation it is used. Hardware, operating system, and application AAM modules might mix information from different portions of the hardware and software environment to provide the most effective ambient representations.

Each AAM could be shown on the same computer monitor, on an adjacent display, or on a hardware peripheral (e.g. tablet computer, haptic device embedded in an office chair, sensorimotor device attached to a user's arm, or any other type of display device). It should be evident that prior advancements in peripheral information displays would enable an AAM display to use any number of different display modalities such as kinesthetic, haptic, tactile, sensorimotor, auditory, visual, olfactory, etc. (e.g. “this website really stinks”). Each AAM could be configured to display various levels of granularity in respect to the operating system, process, or software application to which it is attached.

The optimal granularity for a particular AAM may depend upon the data rates of the underlying software or upon human factors testing. Human factors testing may show that certain AAM refresh speeds and AAM granularity are optimal in respect to a) recognition and association of patterns, and b) optimal level of distraction of a user from their primary tasks. The granularity of the display may also be adaptive with the level of experience of a human user, with the amount of data that is passing through a computing system or an individual software process, or the load imposed by the software instrumentation mechanisms being used to collect the hidden system information.

In some embodiments, the AAM is integrated into a conventional operating system environment so that it can access detailed operating system and application data streams without significant system overhead. There are a wealth of widely available and sophisticated system instrumentation and monitoring facilities available within any commodity operating system. These tools provide mechanisms for measuring real-time data flows through software and operating system components, attached peripherals, and communications hardware (e.g., Ethernet cards).

The level of detail being considered for display may need to be tuned to be appropriate to the potential for threat for a particular system in order to minimize overhead costs of performing instrumentation and monitoring. One skilled in the art might also understand that current software instrumentation mechanisms might not be well-suited for use within an AAM. Lightweight instrumentation mechanisms are needed which collect only the specific inputs needed by the AAM. Most commodity instrumentation systems collect broad ranging system statistics and metadata to provide an all-encompassing view of software and system operation for use within debugging and testing. The purpose of an AAM is far simpler in design than these and less sophisticated instrumentation can be used.

Any of the component interconnections within the physical configuration of a computing device may be instrumented and monitored and the subsequent data represented within an AAM. Some of these devices can be easily monitored using existing instrumentation mechanisms. Some of the devices shows would require modification of the computer system hardware to allow measurements to be used within an AAM.

For example, hard disk accesses (reads and writes) are often displayed within system activity monitors as an event histogram or as aggregate statistics. An AAM might display these same accesses using a similar histogram, but would tie the disk accesses to individual user processes peripherally to the display region of the user process. By ensuring that the disk access AAMs are peripheral to the display of a user process the context can be transparently understood. If a hard disk drive is thrashing due to contention between different processes the AAM will make it evident to a user whether the active task is the culprit. Most other conventional uses of physical system monitoring rely on aggregate statistics do not generally associate the measurements with specific user activities.

In an AAM, simply watching an AAM might indicate from which software process the represented measurements originated. In conventional system activity monitors, the aggregate statistics are unlikely to contain sufficient information to indicate from which process the represented measurements originated.

In simple functional models of an AAM, each data source produces data records “x”. These records are mapped through a mapping function “f” which maps data records into representation(s) suitable for display. In some embodiments, AAMs may use multiple mapping functions, and/or multiple inputs and multiple displays, and/or many data sources, interdependent mapping functions, and many displays.

An AAM represents underlying system metadata that is displayed in the visual (or sensory) periphery. The mapping between inputs and outputs is deterministic. The amount of statistical aggregation or granularity of the mapping between inputs (system metadata) and outputs (the AAM itself in the form of audio, visual, kinesthetic, or other display methods) is crafted to optimize correlation between transitions in hidden system information and displayed representation transitions in the AAM.

Generally, for purposes of an AAM, aggregation is not desirable. Performing statistical aggregation of system information can result in non-real-time display of state transitions and result in the loss of display fidelity. Statistical aggregation techniques can often result in heavy bias of display output based on large aggregates of prior data. Nonetheless, there are instances where statistical aggregations are desired such as for the purpose of reducing the computing cost of software instrumentation.

In one embodiment, an AAM is used to display system metadata representing network application layer communication using the Hypertext Transfer Protocol (HTTP) and HTTP Secure (HTTPS) protocols. This “Web-traffic Ambient Activity Monitor” is intended to provide a computer user with a set of visual-auditory cues correlated to their web-browsing activity. The actual AAM display area is shown visually adjacent to the web-browser display area and produces a sequence of visual elements (squares) which vary in size, horizontal location, color, and auditory tone based on the Internet Protocol (IP) source and destination address, source and destination Transmission Control Protocol (TCP) port, and TCP segment size.

Upon initially requesting a web-page using a web-browser a series of packets are transmitted between the client (user's computer) and server (the computer hosting the web-page being requested) and vice-versa. The series of packets transmitted have characteristics which are fairly consistent over time. Each time a user requests the same web-page a similar set of packets will be sent and received. These packets are transmitted in a fairly predictable manner between multiple requests for the same web page. Between TCP request/response sessions there will generally be many small deviations in packet ordering, packet size (due to fragmentation), timing (due to routing), the number of packets sent and received, and other characteristics.

As an example, the “Web-Browsing Ambient Activity Monitor” may be drawn to a screen in two horizontal regions just below the web-browser window. The source of an IP packet may be shown in a top-most AAM and the destination may be shown in a bottom most AAM. The color, horizontal location, width, and auditory tone of a box may represent its IP address. The vertical height of a colored box and amplitude of the audio tone each independently may represent the TCP segment size. When a user visits a website (such as their banking website) the AAM displays a sequence of colored boxes and the computer's speaker emits a series of audible tones. Each box and each tone each independently represent an HTTP protocol request and response transmitted between the user's web-browser and one or more computer servers which host the content of the webpage.

In the “Web-Browsing Ambient Activity Monitor” embodiment, a conventional method for network packet capture and monitoring is used to capture metadata about the transmission of packets to and from a computer. The metadata collected by the monitoring software is then fed directly into a software translator which maps each metadata value into a visual or auditory display element.

Mapping between system metadata values and AAM display parameters as implemented within the Web-Browsing AAM may involve the metadata source, mapping functions, and AAM output for the metadata associated with the network traffic source, as well as the metadata source, mapping functions, and AAM output for metadata associated with the network traffic destination.

In the instance of this specific embodiment, the IP address is mapped to a pitch range on the diatonic scale such that combinations and sequences of tones are generally somewhat pleasing. If the tones were discordant and displeasing, too high in frequency, or two low then they may present a distraction to the user. The pitch range and notes of this embodiment were chosen to be as pleasing as possible while retaining simplicity in their design. Similarly, the visual implementation is intended to be visually pleasing without being distracting. While it is not necessary that an AAM be stimulating or pleasing, the output is preferred to be acceptable to a user who will be hearing and seeing the AAM's output on a continuous basis.

In the above-described specific implementation, the software used to map system metadata into visual and auditory output is relatively straightforward. More sophisticated implementations may be necessary for other types of system metadata or AAM output (e.g. haptics, sensorimotor feedback, etc.), as recognized by one having ordinary skill in the art. Further, various implementations are possible in any number of programming languages.

Many variations may exist for placing the display area so it is adjacent to the primary user interface display area. In one embodiment, the primary user interface display region and the AAM are always shown such that the AAM is perceptually adjacent to the primary user interface display region. However, it is also possible for an AAM to be shown on an external display. This would most often be used for displaying operating-system-level metadata (rather than the application-specific metadata in this specific implementation).

In some embodiments, an AAM can be interactive. Interaction could be via conventional user interface paradigms such as the keyboard and mouse. These interactions could be used to query the AAM for more information about a specific visual or auditory display element. Interactions could also allow a user to control how a given metadata from a series of system-level events was displayed. For example, if a user visits a specific website many times, but the AAM produces a displeasing or discordant visual or auditory output of the related metadata, the user could click on the AAM display area in order to inform the AAM translation software to produce more pleasing visual and auditory output. Very minimal changes would be required to implement this capability in the Web-Browser AAM.

As an example, in some embodiments, the AAM display is shown using an array of LED display device which is connected to a computing system as an output device. In this embodiment the functional mapping between hidden system information and the AAM maps system changes into an intensity, color, location, and pattern of colored lights which are projected on the wall or office space in front of a user (and behind the display).

In some embodiments, an AAM may use a haptic device which is connected to the computing system as an output device. In such embodiments, the haptic device is directly attached to a user's hand. The hidden system information is mapped to the amplitude, frequency, location, and pattern of haptic activations on a user's hand. Haptic devices could easily be constructed which are attached to other regions of the body. Haptic AAM output devices may also be embedded within clothing or attached to furniture such as desks or chairs. Haptic AAM output devices can also be embedded within computing devices such as the vibration motors commonly embedded within personal electronic devices and wireless telephones.

In some embodiments, an AAM which uses a digital projector which is attached to the computing system as an output device. In this embodiment hidden system information is displayed visually as sequences and patterns of visual imagery on a wall or within the office space of a user. The digital projector may be embedded within the computing system primary display or attached to the primary display. The screen resolution of a digital projector may show representations of hidden system information with greater fidelity.

The embodiments disclosed herein provide a system/method that does not merely provide a visualization of aggregate system data, but rather a mapping of real-time system and software states onto a visual representation which can be used by a human user to predict future states (and to detect differences between their prediction and the displayed state). The embodiments provide a unique combination of the use of human cognition to predict system behavior and correlate it with their own interactions with a computing system, with the functional mechanism (directly mapping system metadata through predictable and deterministic transformation functions), and the display methodology (display of representations in an ambient fashion with the intent of being unobtrusive and visually appealing).

The disclosed embodiments provide a representation of system metadata and a display of this metadata in the visual, sensory, or temporal periphery, involve the use of a non-obtrusive and non-distracting representation, provide an association of the representation with an active task of a human user, and involve use of a non-aggregate, deterministic mapping from input metadata to output display representation.

It should be recognized that many visualization approaches may be used with AAMs, with the best possible representation being dependent upon the type of data being represented, various aspects of the human perceptual system, and the predictions which might are expected to be made by a computer user. Further, iconic representations are not disallowed within an AAM, nor are statistical aggregations. In some cases, the use of iconic representations or statistical aggregations can assist in peripheral or active perception. The disclosed embodiments are not dependent upon not being an aggregated display or an iconic display.

In some embodiments, such as further discussed below, the AAMs are used to perform monitoring of human interactions and perceptual queues. By turning the instrumentation mechanisms outward and monitoring the human operator, some of the AAMs being seen by the operator reflect measurements of their own state and interactions. This represents a form of bio-feedback, but would be displayed in the context of their current task. For example, the operator of a remotely piloted vehicle could receive information about their attentiveness in the context of the current task. If they perceive peripherally that their attention is elsewhere or different than when normally performing the same task they might search for a cause (lack of stimulation, lack of sleep, environmental disturbances, etc.).

As noted above, disclosed herein are embodiments that involve comprehensive supplemental peripheral information concerning software and operating system states so that a human user can better perceive, predict, and adapt to changes, anomalies, and emerging threats to their computing environment. The embodiments apply the theory of “ambient” or “peripheral” information displays to the display of real-time system and process metadata such that the displayed information can be used as event predictors by a human computer user while not demanding direct user attention.

Events which are perceived by a human through use of the embodiments disclosed herein may include threats, anomalies, software and hardware failures, software bugs, and even normal operation of a computer system and its hardware and software components. Representations of events in this invention are generally “abstract”, mapping numeric values into various (and multiple) representations which are visual, auditory, haptic, sensorimotor, kinesthetic, myoelectric, or relating to sensory perception of temperature or pain, and many other sensory modalities suitable for continuous perception by a human user.

The embodiments provide a method for monitoring the human computer user's responses to displayed information. One goal is that the user is better able to detect changes or anomalies and to predict threats when supplemental information about the “computing environment” is peripherally available. The peripheral information display is non-obtrusive and provides consistent visual, auditory, and kinesthetic cues that relate to the flow of information within and between computing systems.

In a complex computing system, anomalous or abnormal behavior can be a symptom of malicious activity or an active threat; however, it can also be a sign of faulty equipment, malfunctioning software code (i.e. bugs or defects), or unexpected external and environmental influences. Defining anomalous or abnormal behavior for simplistic computing systems has traditionally involved manually designed limits or thresholds. When these limits or thresholds are reached, an alarm or alert is activated, prompting a human to examine the situation more closely. This approach is especially common with mission-critical or life-critical systems, such as those in hospitals or power plants. As technology improves and computing systems become more interconnected and more complex, these simplistic approaches become less efficient and less effective. Thresholds may need to be adjusted as the system grows and evolves, and rules governing these thresholds may become complex enough to warrant their own software and algorithms.

Generalized detection of anomalous behavior in complex computing systems is an open research problem. Although recent advances in machine learning (e.g. hierarchical learning) have furthered progress in this area, there are a number of outstanding issues. One issue is defining “normal” behavior in a complex system, or system of systems, especially when normal behavior may depend on outside factors or may be time-variant. Classifying normal behavior is often an algorithmic requirement before classification of abnormal or anomalous behavior can take place. Another issue is defining thresholds for anomaly detection: how different does behavior need to be, and over what time period, in order to exceed some “normal” limitations and become worth examining in greater detail, especially given finite human expertise and resources?

One approach to detecting anomalous or abnormal behavior attempts to train complex machine learning classifiers and attempts to program adaptive thresholds. The approach of the embodiments disclosed herein is to use a human as both the classifier and threshold mechanism. Rather than sending massive amounts of complex and hidden data through machine learning algorithms, the disclosed embodiments transcode that digital data into physical stimuli (e.g. audible sounds, moving patterns, shifting colors) and presents them to a human user. Human users then become classifiers because they can learn and adapt to the stimuli as they interact with the computing system. They become accustomed to complex patterns of stimuli and associate those patterns, even as they evolve, with their interactions.

Internally creating and triggering thresholds will happen naturally as the human users notice unusual behaviors in the transcoded stimuli. The disclosed embodiments provide methods for detecting these triggers, such as by providing the user with an active interaction instrument, such as a button that the user can push when anomalous or abnormal behavior is detected, or by observation and classification of the user's physical responses to the stimuli, such as a shift in attention or increased heart rate. Rather than directly classifying the complex computing system's behavior, the disclosed embodiments make the human user observe the computing system and then classify the human user's response. This indirection works because human behavior and physical responses are often more easily classified than the data being produced by the complex computing system.

Within conventional human-machine interfaces, reliance is almost exclusively on primary attentional information streams. The peripheral is used, but generally limited to event notification in the form of binary indicators of interesting information (time and date, weather, etc.) or the need for user action or response (e.g. emblems on application icons, notifiers in the status-bar of active processes).

As used herein, the term “peripheral” is intended to convey one of several related concepts. In particular, peripheral may indicate perception outside the main focus of attention, information that occurs outside of normal areas for foveation when attention is fixed on an object or region, information that is relevant but not the primary or foundational information used to achieve a goal, or semantic unrelatedness referring to the current content or context being related to the active task (in stark contrast to peripheral aspects relating to physical proximity).

Peripheral information displays have been shown to increase a user's awareness of supplemental knowledge. Nonetheless, only a handful of iconic and graphical display elements are seen within modern computer interfaces providing peripheral information. These are akin to road signs within physical environments which convey meaning in a direct fashion. The peripheral display as discussed herein conveys meaning indirectly via correlation of the state and interactions with a computing display.

To use a similar analogy, this is akin to road, engine, and tire noise providing peripheral cues as to the state of an automobile as it races around a sharp corner, engine revving and tires chirping. If a driver starts to hear crunchy sounds from gravel on the road, or lack of squeaking sounds due to a wet road surface, the peripheral cue is alerting them to a change in the surface condition of the road. A skilled driver who has learned these and other cues can then adapt their behavior to minimize risk.

When a user interacts with a computing device, the underlying state of the machine is generally hidden and only the intended output of a set of active computing tasks is visible. This differs significantly from traversal of a physical environment (e.g. walking down a sidewalk) where the rich environmental milieu provides constant and myriad peripheral cues to the active state of the local environment (e.g. footsteps of other pedestrians, automobile noises, sounds of children playing). These environmental cues, while unrelated to the task at hand (e.g. when the task is walking to a particular destination, the sound of leaves in the wind is unrelated to the task, but informative of environment status), are often necessary for doing so safely (e.g. avoiding a speeding car, or a child on a skateboard).

It is known that threat avoidance in real environments relies on peripheral information. Further, the peripheral information is not a measurement or abstraction of the threat itself, but information that can be used to predict potential threats (whether real or imagined). For example, though the act of walking down the street may be objectively the same when in an urban area compared to a rural area, peripheral environmental indicators of threats are very different in these two scenarios.

Indicators of emerging or current threats to a computing environment are currently provided to a user in several ways: a) Indicators may be provided early, prior to an event which warns us to specific threats (as in an alert or dialog box); b) Indicators may be provided late, after an event (as in the output of an intrusion detection system); or c) Indicators may be provided in the form of a near real-time measurement of network connection, process, or other machine states (such as a process monitor).

In some cases, real-time measurements (such as memory and CPU-time of a running process) may provide subtle hints that something may be awry in much the same way as peripheral cues in natural environments. However, the conventional approach for process monitoring is generally limited for several reasons: a) it is non-peripheral, demanding a user's full attention to engage and understand the information, leaving other tasks underperformed; b) the monitoring representation only captures intended cues, and as such reflects an abstraction and judgment of underlying machine state, rather than a pure representation of the machine state itself, which may leave out information that may be useful; c) processes may be significantly simplified and aggregated for the purposes of exposing particular measurement semantics (i.e. CPU usage percentage, counts of disk reads/writes), rather than for user understanding, potentially rendering uninformative high-level machine states that the user cannot interpret and which do not directly correspond to their current actions and interactions with the computing system (being unrelated to their active task); and d) the processes monitored generally do not correlate precisely with the activities of the user or underlying system state, often being delayed by seconds for purposes of decreasing the process monitor's resource demands. This decreases the likelihood of the user being able to equate their actions and behaviors to the activities of system processes.

There also exist unintended peripheral cues within modern computing system (such as unexpected slowdown of a software application, the erratic behavior of running processes, disk drive noises, fan noises, etc.). However, it is the intent of good software design to eliminate these unintended effects. The computing environment is designed to be sterile in respect to unintended effects. These effects represent bugs or other software deficiencies.

It should be noted that often neither the intended or unintended cues have rich semantics that tie them to user or system activities. A user may be able to direct their attention to a process monitor and see the memory usage of a particular software application, but unless the user is performing complex feats using debuggers and software instrumentation, they do not get any deeper knowledge as to why the memory usage is at a particular level.

As described above, the conventional methods of displaying real-time computing-system-state generally demand a user's full attention within the display environment. Even in the case of real-time monitoring, the information provided within conventional displays is generally superficial and indicators often occur only after nefarious events (e.g. process usage increases after it has been exploited). The disclosed embodiments provide methods and apparatus for providing peripheral information regarding the live state of a computing machine at all times (not just when an issue occurs). The disclosed embodiments intend to remove abstracting decisions, and provide a direct representation of the underlying machine states so that users may learn without bias to associate their actions and system behaviors. The disclosed embodiments will enable the human operator to use these predictive cues as a means to detect abnormalities in system behaviors.

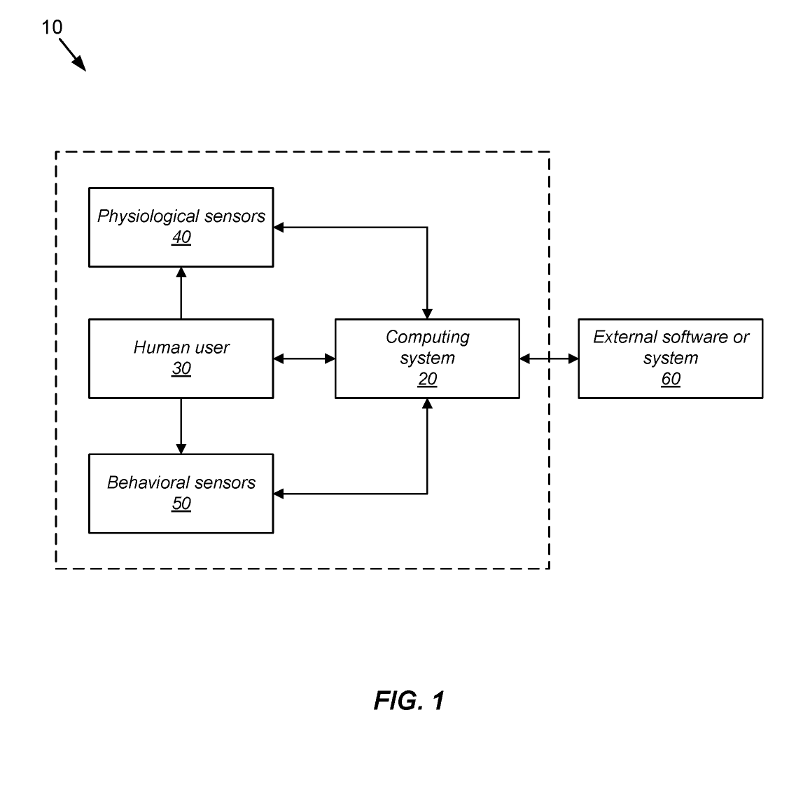

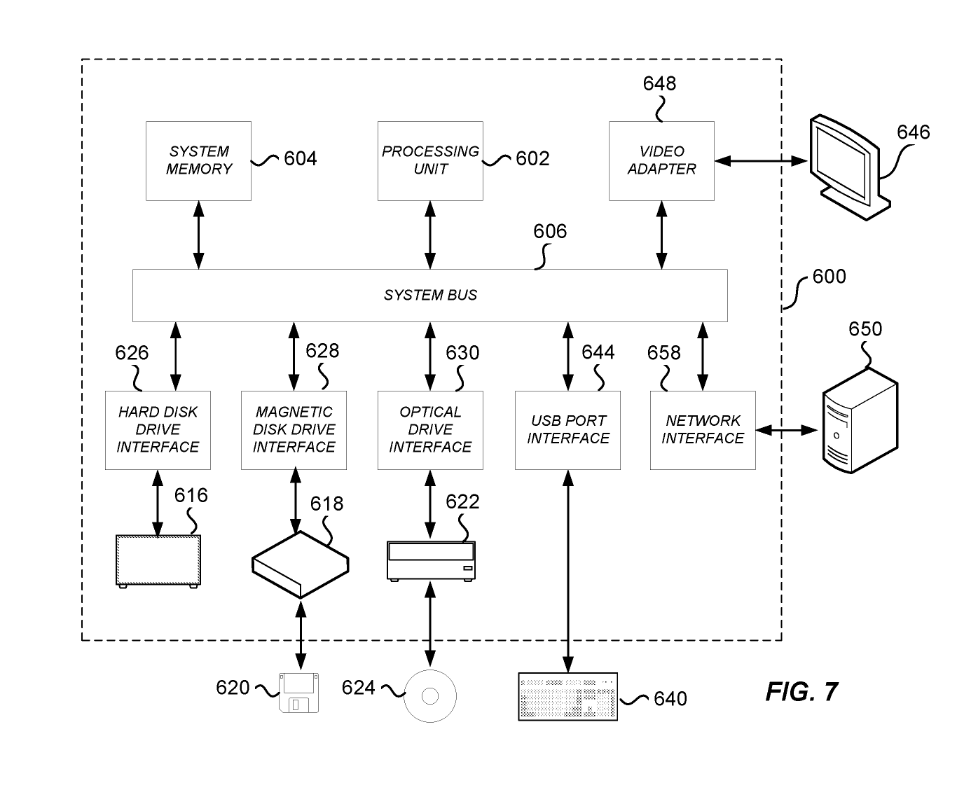

FIG. 1 shows a block diagram of an embodiment of a system 10 that may be used to perform the methods in accordance with the Computer System Anomaly Detection Using Human Responses to Ambient Representations of Hidden Computing System and Process Metadata. System 10 includes a computing system 20, human user 30, physiological sensors 40, behavioral sensors 50, and external software or system 60. Computing system 20 may be any system configured to permit interaction with a human user and perform the specific functions as described herein. One example of a computing system suitable for this purpose is shown and described with reference to FIG. 7.

Human user 30 is a user that is interacting with computing system 20. Such interaction may include, for example, using a software application operating on computing system 20, providing input to computing system 20 via an input device, and having responses measured and/or detected by one or more sensors operatively connected to computing system 20, such as behavioral and physiological sensors.

Computing system 20 is configured to display a representational output to human user 20. It should be recognized that the embodiments disclosed herein do not limit the scope of what can be displayed to solely those data or metadata that have clear semantics. As long as the relationship between state of the machine and the visual, auditory, or kinesthetic display are predictable (i.e. deterministic), then inferred associations can be learned by a human operator. Nonetheless, it is clear that more sophisticated displays can be constructed through the use of natural language processing in combination with event monitoring, state analysis, protocol analysis, and process analysis. These displays may be constructed to provide a peripheral context for the active computing environment, as providing a peripheral context will enable better decisions regarding threat. The approach requires sophisticated software instrumentation and real-time measurements. The resulting peripheral display preferably provides updates in either real-time or (optimally) predictive to potential threats.

In addition to providing human user 30 with a peripheral visualization of hidden system information, the human user may also be instrumented in a complimentary manner. Just as the user is often unaware of hidden states within a computing device, the computing devices that we use today are generally unaware of the psychological and physiological state of the human user. This is a severe limitation on current computing systems which precludes systems from adapting to user behavior, physiological responses, or stress levels. A system that takes careful, real-time measurements of human physiology will be capable of adapting computing system behavior, performance, and peripheral display characteristics to accommodate changes in a user's behavior.

In essence, computing systems without knowledge of human physiology are incapable of adapting to either conscious or subconscious changes to the innate state of the human user. When combined with our ambient peripheral display capability, the system can be optimized for reasons of improving user performance. Additionally, information collected from human user 30 may be used to inform computing system 20 when a threat (or unexpected sensory stimuli) is detected.

The Peripheral Display (PD) processes data and metadata from various operating system and software components and produces perceptually appealing “projection” (e.g. visual, tactile, and kinesthetic) of these data into one of several associated display regions. Generally, this data represents the internal latent and active state of the software system. For example, the data processed by each PD may represent the state of the computing device or actively running software or process. The “projection” of the data is performed such that it lies to the periphery of the human perceptual system. In this way, hidden system and process metadata is displayed in a way that is unobtrusive, but allows the human perceptual system to naturally learn to associate their actions within the computing environment to system outcomes.

Deviations from perceptual expectations can then be detected by the human computer operator as perceptual cues which could be acted on directly by human user 30. In this way, behavioral modifications based on these cues may prevent, acknowledge, or otherwise act on new and emerging threats. This approach differs significantly from other security visualization systems (which are used in a primary display mode) or with existing peripheral display systems (e.g. Mac OS X Dashboard) which display “information” such as weather or stock prices.

The data processed by the PDs are not information retrieved from online or local information resources for the purposes of “information awareness”, but are the currently hidden states internal to a computing machine and its communication. PDs do not display “information”, but graphical, auditory, haptic, and kinesthetic “graphics” which are associated with, and derived from, user and system actions and interactions. If taken out of context of an operating system or software application, the PD would lose its meaning and appear only as abstract (although perhaps still pleasing) shapes, sounds, touch, and movement.

Conventional peripheral “information displays” contain informative icons and numeric values, and can be easily understood in any context (e.g. a stock histogram, a current weather display using icons, a news ticker, a conventional software process monitor, etc.). In the disclosed embodiments, the semantics of each PD must instead be inferred over time and experienced by a human user 30 (e.g. If a user goes to website X then a specific pattern appears next to the user's browser window. If the user is directed to the wrong website, the pattern is not the same and violates expectations).

The display of a PD is deterministic and represents a strict functional mapping between the state of the computing system and the display. The PD may also be constructed to either accentuate or diminish small differences in the data. In a diminishing mode the same or similar set of input data may produce a similar displayed form. It should be understood that in order to produce a graphical display which is similar for similar data, that the mapping functions between input data and the PD will often be mathematically smooth where small changes in input values result in small changes in the representation and large changes in input values result in large changes in the representation. Depending upon the input data, there may also be mapping functions which produce large discrete changes for small changes in input data. This would be desired in some instances in order to accentuate and disambiguate data that are mathematically adjacent or are members of an enumerated set (e.g. computer internet protocol ports, similar website domain names).

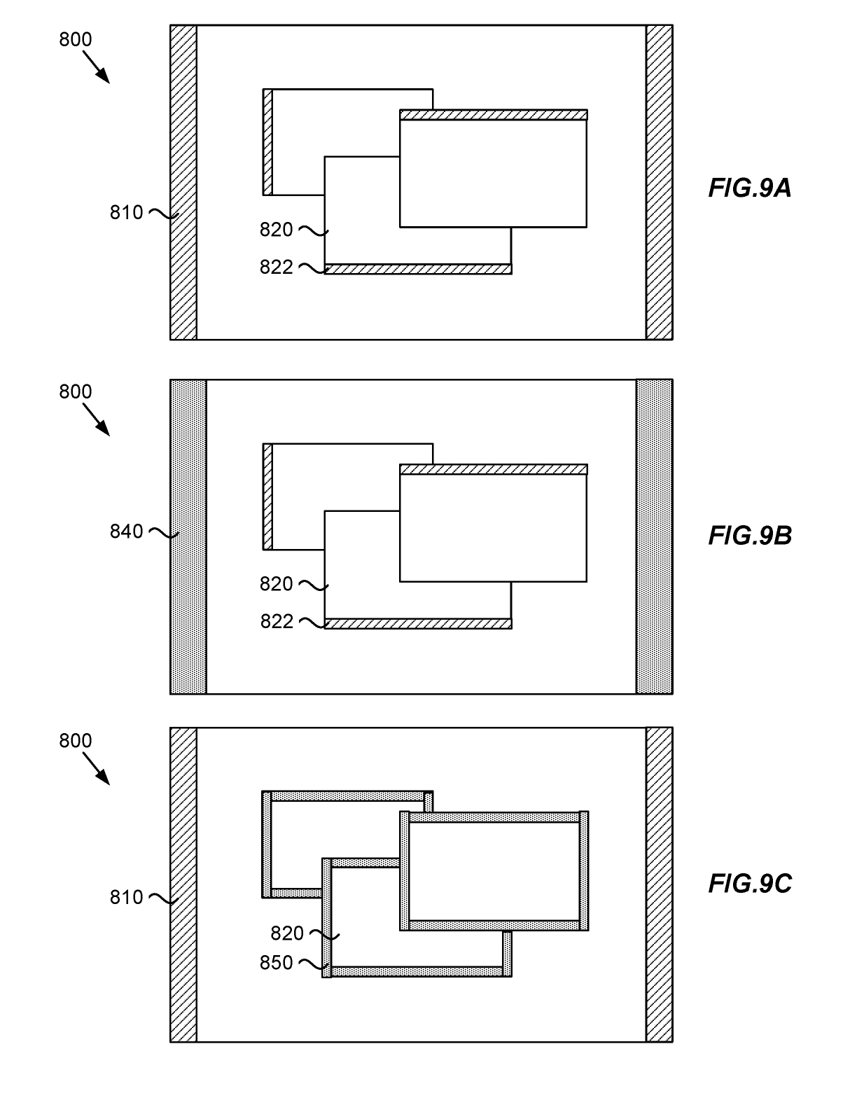

Each running PD may operate concurrently in one or more modes. An operating system mode is attached to and sits visually adjacent to the primary view of an operating system (e.g. Microsoft Windows, Apple Mac OS, Linux). A software application mode sits visually adjacent to particular application window (or multiple windows belonging to the same application). A daemon mode sits visually adjacent to and subtended to the PD of a parent process (i.e. to an operating system mode PD or a software application mode PD). FIGS. 9A-9C show the attachment of PDs to a software application and operating system.

In some embodiments, each PD could be shown on the same computer monitor, on an adjacent display, or on a hardware peripheral (e.g. tablet computer, or other display enabled device). As in several prior advancements in peripheral information displays, the displays may also be kinesthetic, haptic, auditory, olfactory, etc. Each PD could be configured to display various levels of granularity in respect to the operating system or software application to which it is attached.

The optimal granularity for a particular PD may depend upon the data rates of the underlying software or upon human factors testing. Human factors testing may show that certain PD refresh speeds and PD granularity are optimal in respect to a) recognition and association of patterns, and b) optimal level of distraction of a user from their primary tasks. The granularity of the display may also be adaptive with the level of experience of a human user, or with the amount of data that is passing through a computing system or an individual software process.

Physiological sensors 40 may comprise any sensor that is configured to detect/measure a physiological aspect of human user 30. Behavioral sensors 50 may comprise any sensor that is configured to detect/measure a behavior of human user 30. Physiological sensors 40 and behavioral sensors 50 may be configured to detect/measure one or more of the following parameters from human user 30: galvanic skin response, respiration rate, heart rate, eye movement and saccades, skin temperature, skin resistance, skin color, eye pupil dilation, electroencephalogram (EEG) measurements, myoelectric and muscle tension, posture, head movement, hand movement and gestures, electrocardiograph, facial expressions and micro-expressions, non-invasive blood oxygen saturation, and blood pressure.

In some embodiments, physiological sensors 40 and behavioral sensors 50 may comprise systems/devices/hardware configured to connect to human user 30 and computing system 20. Examples of devices that may be used for sensors 40 and/or 50 include those shown and described in U.S. Pat. No. 6,067,468 to Korenman et al., titled “Apparatus for Monitoring a Person's Psycho-Physiological Condition”, and U.S. Pat. No. 5,741,217 to Gero, titled “Biofeedback Apparatus”, the content of which are incorporated by reference herein.

Behavioral and physiological measures extracted from human user 30 while interacting with computing system 20 could help to refine the parameters of the sensory feedback methods used by the PD. There are many possible use cases. Specifically, measurements of human physiology could be used to update the intensity of a peripheral display, either to diminish the intensity so as not to be distracting, or to increase the intensity to ensure that changes to the visualization as perceptible. This is beneficial as users may have varying degrees of perceptiveness in respect to the peripheral display. The peripheral display could be designed in such a way as to insert intentional novelties in the visualization and to calibrate the intensity based on physiological and behavioral measurements taken of human user 30.

Additionally, these measures could be useful in testing the utility of PDs in user tests by measuring changes in response to the presence of PDs and identification of learned associations of sensory feedback to computer information. For example, certain brain wave patterns indicate that human users 30 may have detected an anomalous event in their environment. By feeding these data, from an EEG (electroencephalography) or other brain monitoring system, into the PD, it can gain awareness of whether a current presentation caught the attention from human user 30. Because all brain-state detected anomalies are not always acted upon, it may also provide a method for changing the refresh speed, granularity, overall display technique, display intensity, or other general display characteristics of the display of computing system 20 in order to improve the saliency of its signal.

Other physiological measures such as gaze location, pupil diameter, and heart rate could also provide indicators of attentional shifts or stress, fatigue or other cognitive states that relate to the ability to detect anomalies. Behavioral measures, such as key stroke duration/intensity, mouse clicks/movements, and switching between applications could also be useful in determining learning patterns. User testing may reveal certain thresholds of sensory feedback salience are more optimal, but importantly this is a method for establishing, understanding, and balancing the distraction potentially created by a PD with sustained situational awareness of hidden computer state changes.

In some embodiments, external system or software 60 may be any system or software that is located external to computing system 20, human user 30, physiological sensors 40, and behavioral sensors 50. As an example, external system 60 may be another computing system operating over the same network as computing system 20. As another example, external software 60 may be a software application that is run on a computing system networked with computing system 20.

In some embodiments, external system 60 may be configured to provide feedback to computing system 10. As an example, external system 60 may provide data to computing system 10 for informational purposes and/or may provide data to computing system 10 for processing by computing system 10.

In some embodiments, the disclosed methods are integrated into a conventional operating system environment so that it can access detailed operating system and application data streams without significant system overhead. There are a wealth of widely available and sophisticated system instrumentation and monitoring facilities available within most operating systems. These tools provide mechanisms for measuring real-time data flows through software and operating system components, attached peripherals, and communications hardware (i.e. Ethernet cards). Sophisticated system instrumentation, however, is not free. The level of detail being considered for display may need to be tuned to be appropriate to the potential for threat for a particular system in order to minimize overhead.

Any of the component interconnections within the physical configuration of computing system 20 may be instrumented and monitored, and the subsequent data represented within a PD. Some of these devices can be easily monitored using existing instrumentation mechanisms. For example, hard disk accesses (reads and writes) are often displayed within system activity monitors as an event histogram or as aggregate statistics. A PD might display these same accesses using a similar histogram, but would encode the disk accesses to individual user processes, and to the peripheral display region of the user process. By ensuring that the disk access PDs are peripheral to the display of a user process, the context becomes more transparent, and more easily understood. Most other conventional uses of physical system monitoring rely on aggregate statistics, and do not associate the measurements with specific system activities. In a PD, simply watching a PD might predict from which process displayed measurements originated. In conventional system activity monitors, the aggregate statistics are unlikely to contain sufficient information to predict from which process the signal originated.

There are several differences between the embodiments disclosed herein and state-of-the-art peripheral information displays seen within commodity operation systems or in industry or academic research. One difference is that the disclosed embodiments serve to display underlying meta-data, which concerns the active state of network connections, of internal and external software application states, and of internal and external operating system states. There exists many systems which display such information, but no known systems represent this information in the form of a peripheral (supplemental) display.

There exists a wealth of process and system monitoring software, which displays aggregate system information as peripheral information displays (graphs or numeric values). However, the disclosed embodiments are not a visualization (auditory, visual, haptic, etc . . . ) of aggregate system data, but a mapping of real-time system and software states onto a representation which can be used by a human user to predict future states (and to detect differences between their prediction and the displayed state).

The disclosed embodiments uniquely combine the utilization of human cognition to predict anomalous system behavior and correlate it with their own interactions with a computing system, along with the functional mechanism of directly mapping system metadata through predictable and deterministic transformation functions for display in an unobtrusive and appealing manner. As such, the disclosed embodiments are advantageous in that:
1. The PD is by definition peripheral. Many security visualization systems offer some of the PD system's capabilities when used in a primary mode, but require the full attention of human user 30. The primary user task in such systems is the detection of threats. With respect to this invention, prior approaches represent a confusion of the primary display (and primary task) and the peripheral display. Such a system may itself be the victim of attack and would thus benefit by the incorporation of a PD system that augments the human user's awareness of the present state of the underlying system.
2. Associations between the PD and semantics (meaning) is learned over time by a user, rather than made explicit through iconic, textual, or numeric displays. This allows a human operator to learn associations that were not known when the PD system was designed. Since the system is not making pre-determined choices on semantics, it is left to the perceptual and cognitive acuity of the user to detect new anomalies and threats. Conventional peripheral information displays use a fixed mapping between semantics and representation (e.g. icons, text annotations, numeric values, etc.).
3. Each PD is a representation of real-time (or predicted) system state and generally not of aggregated state or statistics over state(s). This allows the human operator to perform feature selection and to associate the active task(s) with the most salient features. Conventional peripheral information displays assume ahead of time which features are important and calculate statistics, which are then displayed. These statistics essentially hide the underlying data and prevent perception of salient features.
4. Each PD is associated with a live portion of the operating system or running software. This is made explicit through visual adjacency within the windowing environment of the operating system. Conventional peripheral information displays are most often independent of their placement within a windowing environment.
5. Explicit training or instruction for human users 30 is not required. Use of the PD invention assumes that the PD are present within and during normal use of the computing system. Over time, the user will learn associations between the PD and the behavior of various software components and their own activities as computing system users.
6. Because the PD represents explicit states within an operating system or software application, the PD can be linked to context menus or to debugging and tracing systems such that the user can directly query the system and retrieve the underlying state of the system. This state could be a system trace showing execution paths, or could be a bundle of packets representing traffic between their machine and outside services. If a user notices that the state of the PD does not match their expectations, they can actively pursue detailed system state information. This differs substantially from current devices in that process monitors tend to either be statistical aggregations or explicit states (traces). The PD invention allows an intermediate form that displays a graphical one-to-one representation, which is often perceived as an aggregate by the human perceptual system but can be directly mapped to explicit states as no actual aggregation is occurring.
7. The PD system can be augmented by creating a feedback loop between human physiological and behavioral measures and the sensory feedback representation by increasing or decreasing the salience of the system information to optimize utility while mitigating distraction of the PD.

Many visualization approaches are possible with PDs. Disclosed herein are not all possible mechanisms of representing system metadata. The best possible representation is dependent upon the type of data represented and various aspects of the human perceptual system. Each data represented will require careful design and substantial human factors testing.

Iconic representations are not disallowed within a PD, nor are statistical aggregations. In some cases, the use of iconic representations or statistical aggregations can assist in both peripheral and active perception. The embodiments disclosed herein are not dependent upon not being aggregated display or an iconic display.

In some embodiments, PDs may be used to perform monitoring of human interactions and perceptual queues. By turning the instrumentation mechanisms outward and monitoring the human operator, some of the PDs being seen by the operator could reflect measurements of their own state and interactions. This would represent a form of bio-feedback, but would be displayed in the context of their current task. For example, the operator of a remotely piloted vehicle could receive information about their attentiveness in the context of the current task. If they perceive peripherally that their attention is elsewhere (distraction) or different than when normally performing the same task, they might search for a cause (lack of stimulation, lack of sleep, environmental disturbances, etc.). Similarly, the computing system, by receiving and processing physiological and behavioral measurements from the human user, can estimate the human user's awareness of a computing system's behavior. If the computing system is aware of a relevant system state or threat and the computing system is also aware that the human user is psychologically unaware of the issue or threat, it can highlight or even interfere with the user's active task in order to ensure the user is made aware.

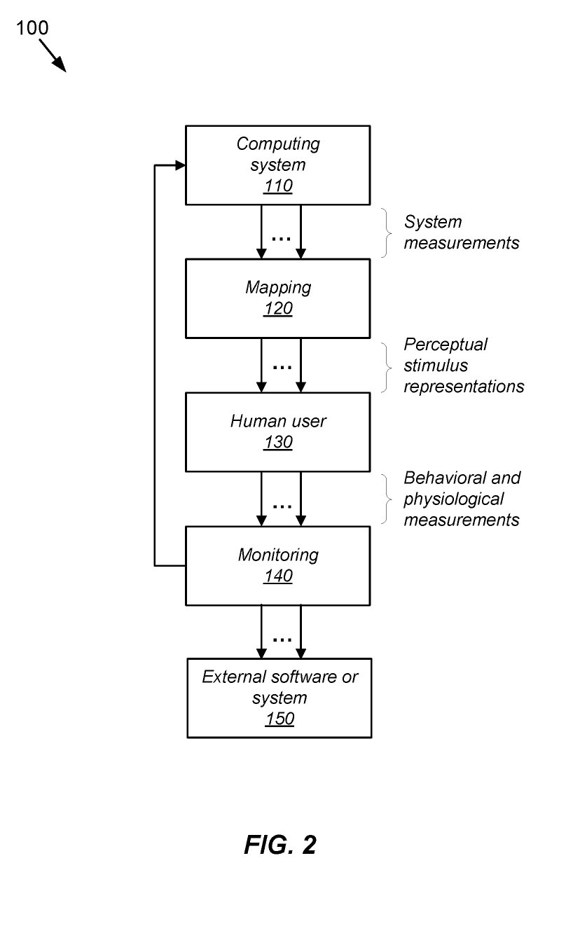

FIGS. 2-6 show process flowcharts of different embodiments of methods/systems in accordance with the disclosure herein. FIG. 2 shows a process flowchart of an embodiment of a feed-forward ambient activity monitor method 100 using human measurements. The process begins with computing system 110, which performs measurements of hidden states internal to the computing system related only to a user's active task with the computing system, as discussed above. At box 120, one or more deterministic mapping functions are used to directly map, without interpretation of the hidden states as being benign or malicious, the measurements to a representational output, which does not label information pertaining to the hidden states. At box 130, this representational output is presented to a human user 130 in real-time and peripheral to the user's active task with computing system 110. At box 140, monitoring/measuring of the human user's behavioral and physiological states occurs. At box 150, the output of the monitoring/measuring is provided to an external system or software, as discussed above.

In some embodiments and as shown by the arrow, the output of the monitoring/measuring at box 140 is provided back to computing system 110. Computing system 110 may use the information, for example, for informational purposes or to modify one or more parameters of computing system 110 and/or any of the sensors connected to computing system 110.

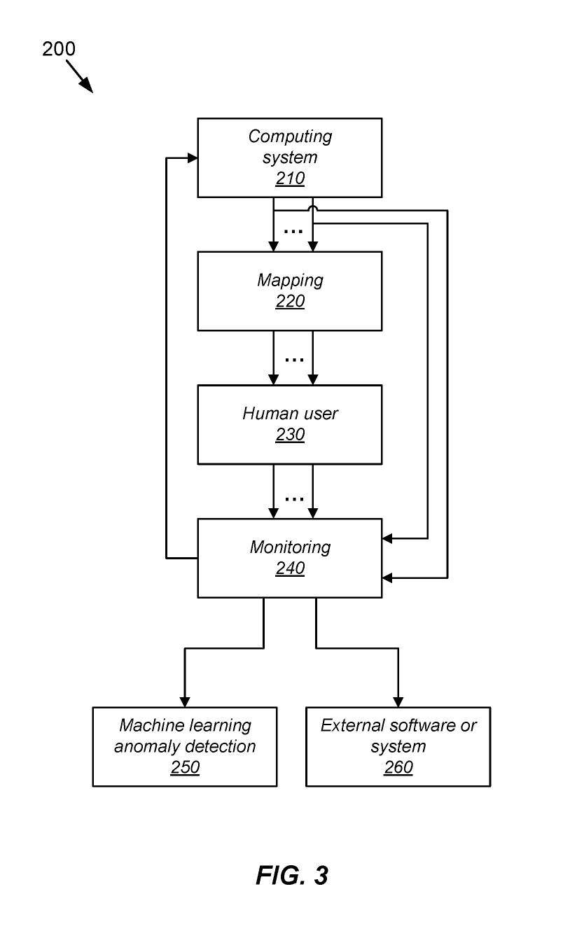

FIG. 3 shows a process flowchart of an embodiment of a feed-forward ambient activity monitor method 200 using both human and computing system measurements for anomaly detection. The process begins with computing system 210, which performs measurements of hidden states internal to the computing system related only to a user's active task with the computing system, as discussed above. These computing system measurements are then used in the mapping function at box 220, which may be the same as discussed above, as well as used in the monitoring/measuring at box 240. At box 230, the representational output from box 220 is presented to a human user 230 in real-time and peripheral to the user's active task with computing system 110. At box 240, monitoring/measuring of the human user's behavioral and physiological states occurs, as well as of the computing system measurements from box 210. The output of the monitoring/measuring may then be provided to a machine learning anomaly detection algorithm at box 250, to an external system or software at box 260, or back to computing system 210 as shown by the arrow and as discussed above.

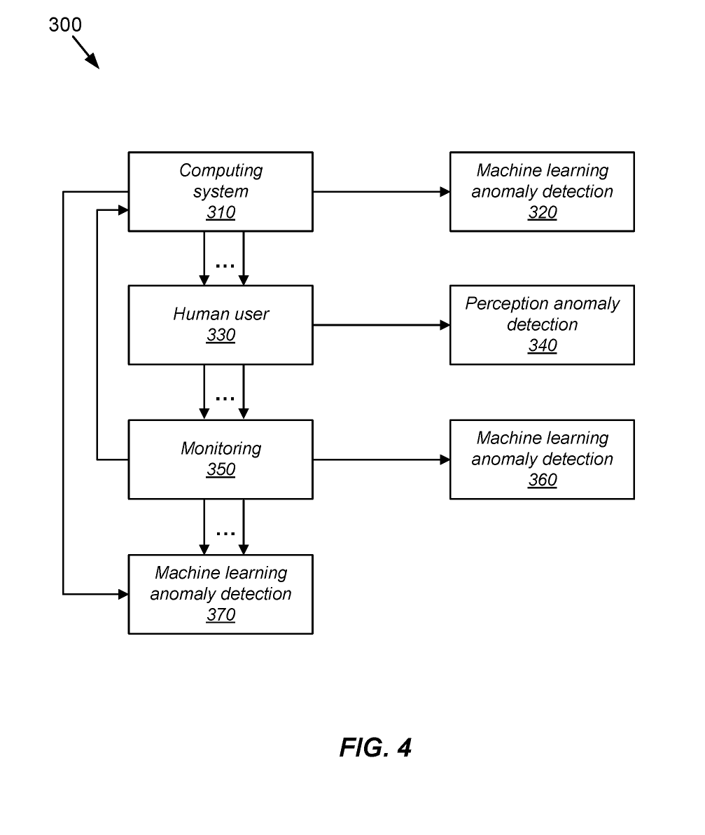

FIG. 4 shows a process flowchart of an embodiment of a method 300 using anomaly detection algorithms using measurements from the computing system, human perception and decisions, and sensor measurements of human behavior and physiology. The process begins with computing system 310, which performs measurements of hidden states internal to the computing system related only to a user's active task with the computing system, as discussed above. At this point, the computing system measurements may be provided to a machine learning anomaly detection algorithm at box 320 and/or used along with one or more deterministic mapping functions are used to directly map, without interpretation of the hidden states as being benign or malicious, the measurements to a representational output, as is discussed above.

At box 330, this representational output is presented to a human user in real-time and peripheral to the user's active task with computing system 310. At box 340, the human user can provide perception anomaly detection based upon the human's response to the presented representational output. In some embodiments, this detection is provided via the human's physiological and/or behavioral response to the presented representational output. At box 350, monitoring/measuring of the human user's behavioral and physiological states occurs. At box 360, the output of the monitoring/measuring may be provided to a machine learning anomaly detection algorithm. At box 370, the output of the monitoring/measuring is provided to an external system or software, as discussed above. In some embodiments, the output of the monitoring/measuring step is provided back to computing system 310 for purposes such as those discussed above.

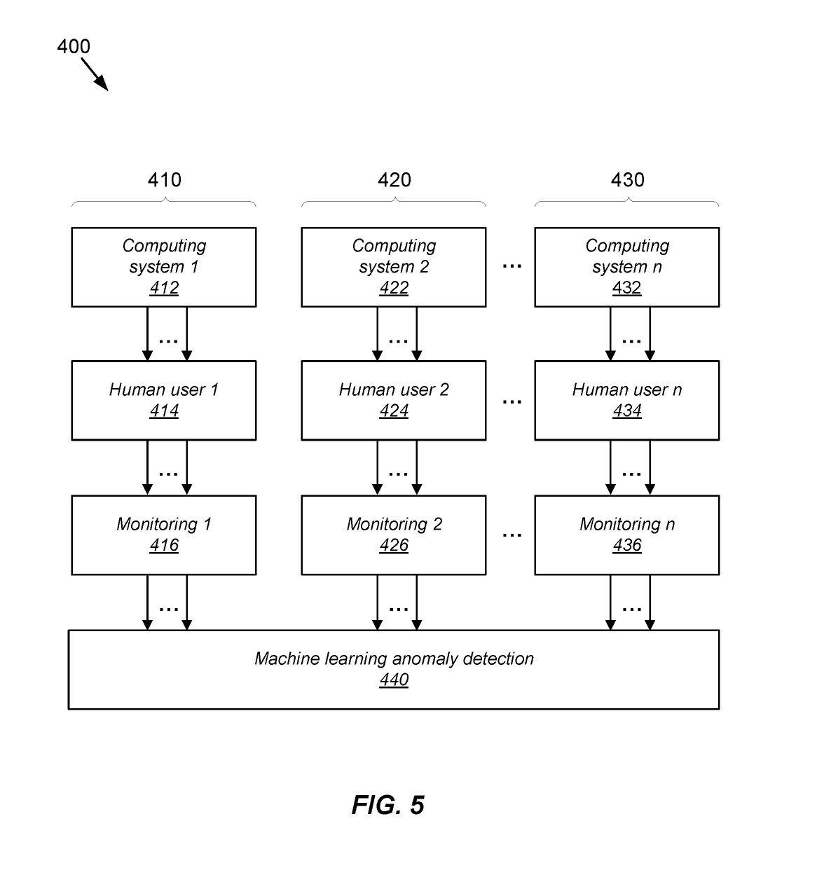

FIG. 5 shows a process flowchart of an embodiment of a feed-forward ambient activity monitor method 400 for anomaly detection using measurements from a plurality of computing systems and human users. Method 400 may be similar to method 300 in process steps, but using multiple computing systems and human users. As shown, there are 1 to n groups of computing systems/users 410, 420, 430, which provide output to a machine learning anomaly detection algorithm/system 440. Group 410 includes a first computing system 412, a first human user 414, and a first monitoring process 416. Group 420 includes a second computing system 422, a second human user 424, and a second monitoring process 426. Group 430 includes an nth computing system 432, an nth human user 434, and an nth monitoring process 436. By combining the results from multiple systems/users 410, 420, and 430, more rapid and more accurate anomaly detection may be possible.

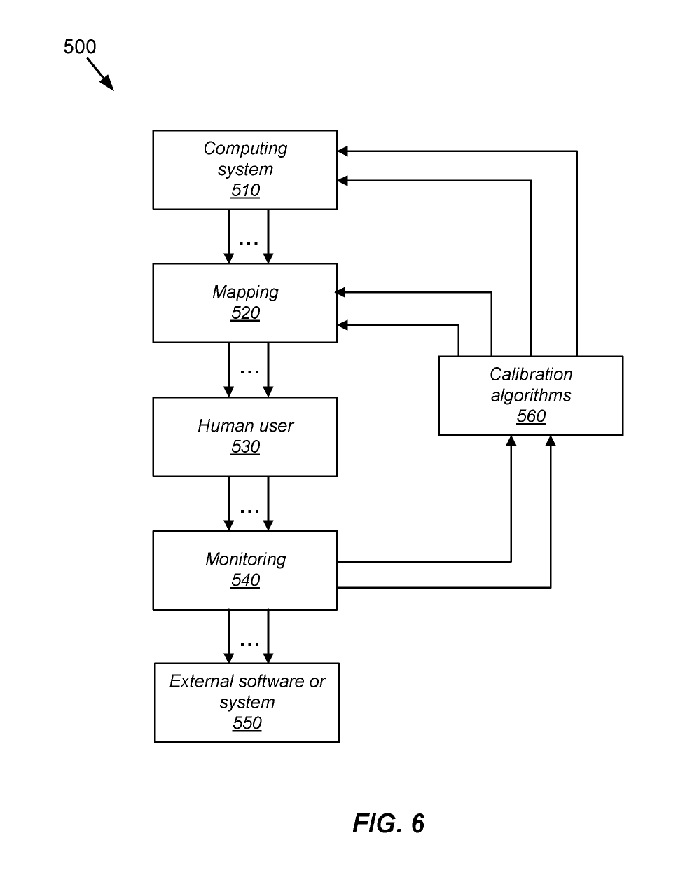

FIG. 6 shows a process flowchart of an embodiment of a method 500 using human measurements to modify system behavior and calibrate visualization mapping functions. The process begins with computing system 510, which performs measurements of hidden states internal to the computing system related only to a user's active task with the computing system, as discussed above. At box 520, one or more deterministic mapping functions are used to directly map, without interpretation of the hidden states as being benign or malicious, the measurements to a representational output, which does not label information pertaining to the hidden states. This representational output is presented to a human user 530 in real-time and peripheral to the user's active task with computing system 510.

At box 540, monitoring and/or measuring of the human user's behavioral and physiological states occurs. At box 550, the output of the monitoring/measuring is provided to an external system or software, as discussed above. At box 560, the output of the monitoring/measuring is provided to one or more calibration algorithms that use the measurements to provide feedback to computing system 510 and for the mapping function at box 520 to modify system behavior and calibrate visualization mapping functions.

FIG. 7 shows an embodiment of a computing system 600 that may be used to perform the methods as discussed herein. FIG. 7 and the following description are intended to provide a brief, general description of a suitable computing environment in which an embodiment of the method discussed herein may be implemented. Although not required, the method will be described in the general context of computer-executable instructions, such as program modules, being executed by a computer. Moreover, those skilled in the art will appreciate that embodiments of the method may be practiced with other computer system configurations, including hand-held devices, multiprocessor systems, microprocessor-based or programmable consumer electronics, networked personal computers, minicomputers, mainframe computers, and the like. Embodiments of the method may also be practiced in distributed computing environments where tasks are performed by remote processing devices that are linked through a communications network. In a distributed computing environment, program modules may be located on both local and remote memory storage devices.

System 600 may include a computing device in the form of a computer 600, which includes processing unit 602, system memory 604, and system bus 606 that operatively couple various system components to other system components (e.g., system bus 606 operatively couples system memory 604 to processing unit 602). Examples of system bus 606 include a memory bus, memory bus controller, peripheral bus and local bus using any of a variety of known bus structures. System memory 604 may include read only memory, random access memory, and a basic input/output system.

System 600 further includes hard disk drive 616 for reading from and writing to a hard disk (not shown) a magnetic disk drive 618 for reading from or writing to a removable magnetic disk 620 (e.g., 4.5-inch disk), and an optical disk drive 622 for reading from and writing to a removable optical disk 624 (e.g., CD-ROM and DVD). Hard disk drive 616, magnetic disk drive 618 and optical disk drive 622 are operatively connected to system bus 606 via hard disk drive interface 626, magnetic disk drive interface 628 and optical drive interface 630, respectively. The drives and their associated computer-readable media provide non-volatile storage of computer readable instructions, information structures, program modules and other information for personal computer 600.

The method steps of embodiments may be stored on a hard disk, magnetic disk 620, and optical disk 624. Although the exemplary environment described herein employs a hard disk, magnetic disk 620 and optical disk 624, it should be appreciated by those skilled in the art that other types of computer readable media that may store information accessible by a computer, (e.g., magnetic cassettes, flash memory cards, digital video disks, Bernoulli cartridges, random access memories (RAMs), and read only memories (ROMs)) may also be used in the exemplary operating environment without departing from the scope or spirit of embodiments of the method.

A user may enter commands and information into personal computer 600 via input devices such as keyboard 640 and pointing devices (e.g., mouse and trackball) (not shown in FIG. 3). Examples of input devices include a microphone, joystick, game pad, and satellite dish. Input devices may be operatively connected to processing unit 602 via universal serial bus (USB) port interface 644 that is operatively connected to system bus 606. Input devices may also be operatively connected to processing unit 602 via other interfaces (e.g., parallel port, serial port and game port) that are operatively connected to system bus 606. Monitor 646 is operatively connected to system bus 606 via video adapter 648.

Other peripheral devices (e.g., speakers and printers) may be operatively connected to system 600 via other interfaces. System 600 may operate in a networked environment using logical connections to one or more remote computers such as remote computer 650 via network a network, such as a local area network, wide area network, and wireless network. Examples of remote computer 650 include a personal computer, server, router, networked personal computer, peer device, and network node.

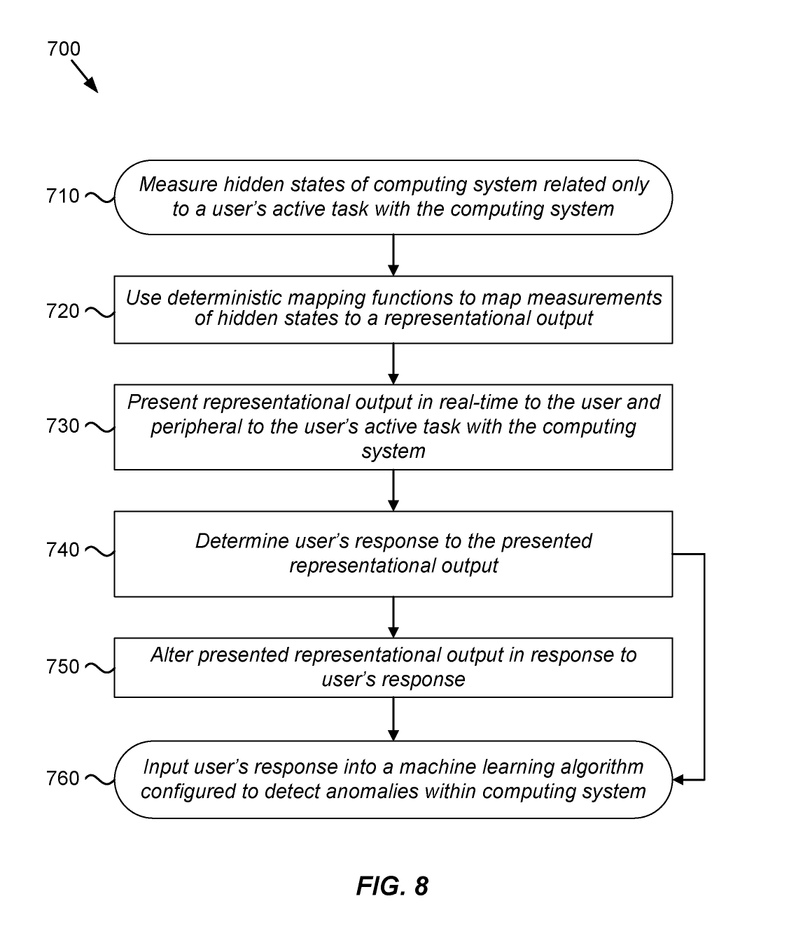

FIG. 8 shows a flowchart of an embodiment of a method 700 in accordance with the Computer System Anomaly Detection Using Human Responses to Ambient Representations of Hidden Computing System and Process Metadata. While FIG. 8 shows one embodiment of method 700 to include steps 710-760, other embodiments of method 700 may contain fewer or more steps. Further, while in some embodiments the steps of method 700 may be performed as shown in FIG. 8, in other embodiments the steps may be performed in a different order, or certain steps may occur simultaneously with one or more other steps. As an example, method 700 will be discussed with reference to the system shown in FIG. 1 herein.

Method 700 may begin with step 710, which involves measuring one or more hidden states internal to a computing system 20 related only to a user's active task with computing system 20. Step 720 involves using one or more deterministic mapping functions to directly map, without interpretation of the hidden states as being benign or malicious, the measurements to a representational output. Step 730 involves presenting the representational output in real-time and peripheral to the user's active task with 20 computing system, such as shown in boxes 810 and 822 in FIG. 9A. In step 730, the presented representational output does not label information pertaining to the hidden states.

Step 740 involves determining the human user's 30 response to the presented representational output. In some embodiments, the user's response is one or more physiological responses as captured by physiological sensors 40. In some embodiments, the user's response is one or more behavioral responses as captured by one or more behavioral sensors 50. In some embodiments, the user's response is one or more physiological responses and one or more behavioral responses.

Non-limiting examples of physiological responses include a body rate of the user, a level of brain activity of the user, and a level of skin perspiration of the user. Non-limiting examples of behavioral responses include a facial expression of the user, a movement of the user, a user's interaction with an input device to the computing system, and a user's interaction with one or more software applications operating on the computing system. For example, the input device may be at least one of a keyboard, touch-screen display device, and a mouse as shown in FIG. 7.

In some embodiments, method 700 proceeds directly to step 750, which involves altering the presented representational output based on the user's response to the presented representational output, examples of which are shown in FIGS. 9B and 9C. As an example, if the user's response is one or more physiological responses, step 750 involves altering the presented representational output based upon the one or more physiological responses. Further, if the user's response is one or more behavioral responses, step 750 involves altering the presented representational output based upon the one or more behavioral responses. Additionally, if the user's response is one or more behavioral responses and physiological responses, step 750 involves altering the presented representational output based upon the one or more behavioral responses and physiological responses.

In some embodiments, step 750 involves altering one or more display characteristics of the presented representational output. As an example, the display characteristics include one or more of the size, shape, and intensity of the presented representational output. FIGS. 9A-9C show diagrams of a display screen 800 illustrating the alteration of an operating system level and software application level representational output presented to a user responsive to the user's response to the initially presented representational output.

In FIG. 9A, screen 800 includes representational output portions 810 that have a particular pattern as mapped in response to measurements of hidden states and displayed by the computing system, such as computing system 20. Portions 810 may be considered operating system level representational output and are displayed, for example, on the sides of screen 800. Screen 800 also includes three software application windows 820 each having a representational output portion 822 on one of the top, bottom, or side of the window.

FIG. 9B shows a modification of the operating system level representational output portion 810 in response to a user's behavioral and/or physiological response to representational output portion 810, or the user's lack behavioral and/or physiological response to representational output portion 810. As shown, the modified representational output portion 840 is wider than portion 810 and contains a different pattern than portion 810. It should be recognized however, that this is one example of how the presented representational output may be modified and that other size, shape, and/or placement modifications may be made by one having ordinary skill in the art.

FIG. 9C shows a modification of the software application level representational output portion 822 in response to a user's behavioral and/or physiological response to representational output portion 822, or the user's lack behavioral and/or physiological response to representational output portion 822. As shown, the modified representational output portion 850 is contains a different pattern than portion 822 and is located all around window 820 versus only being located on just one side of window 820. It should be recognized however, that this is one example of how the presented representational output may be modified and that other size, shape, and/or placement modifications may be made by one having ordinary skill in the art.

In some embodiments, method 700 proceeds directly to step 760 from step 740. Step 760 involves inputting the user's response to the presented representational output into a machine learning algorithm that is configured to detect an anomaly within the computing system using the user's response. In some embodiments, the machine learning algorithm is further configured to detect an anomaly within the computing system using the measured one or more hidden states internal to the computing system in addition to the user's response to the presented representational output.

Method 700 may be implemented as a series of modules, either functioning alone or in concert, with physical electronic and computer hardware devices. Method 700 may be computer-implemented as a program product comprising a plurality of such modules, which may be displayed for a user.

Various storage media, such as magnetic computer disks, optical disks, and electronic memories, as well as non-transitory computer-readable storage media and computer program products, can be prepared that can contain information that can direct a device, such as a micro-controller, to implement the above-described systems and/or methods. Once an appropriate device has access to the information and programs contained on the storage media, the storage media can provide the information and programs to the device, enabling the device to perform the above-described systems and/or methods.

For example, if a computer disk containing appropriate materials, such as a source file, an object file, or an executable file, were provided to a computer, the computer could receive the information, appropriately configure itself and perform the functions of the various systems and methods outlined in the diagrams and flowcharts above to implement the various functions. That is, the computer could receive various portions of information from the disk relating to different elements of the above-described systems and/or methods, implement the individual systems and/or methods, and coordinate the functions of the individual systems and/or methods.

Many modifications and variations of the Computer System Anomaly Detection Using Human Responses to Ambient Representations of Hidden Computing System and Process Metadata are possible in light of the above description. Within the scope of the appended claims, the embodiments of the systems described herein may be practiced otherwise than as specifically described. The scope of the claims is not limited to the implementations and the embodiments disclosed herein, but extends to other implementations and embodiments as may be contemplated by those having ordinary skill in the art.

We claim:

1. A method comprising the steps of:
measuring one or more hidden states internal to a computing system related only to a user's active task with the computing system;
using one or more deterministic mapping functions to directly map, without interpretation of the hidden states as being benign or malicious, the measurements to a representational output;
presenting the representational output in real-time and peripheral to the user's active task with the computing system, wherein the presented representational output does not label information pertaining to the hidden states; and
determining the user's response to the presented representational output.

2. The method of claim 1 further comprising the step of altering the presented representational output based on the user's response to the presented representational output.

3. The method of claim 2, wherein the user's response is one or more physiological responses, wherein the step of altering the presented representational output comprises altering the presented representational output based upon the one or more physiological responses.

4. The method of claim 3, wherein the one or more physiological responses comprise a body rate of the user.

5. The method of claim 3, wherein the one or more physiological responses comprise a level of brain activity of the user.

6. The method of claim 3, wherein the one or more physiological responses comprise a level of skin perspiration of the user.

7. The method of claim 2, wherein the user's response is one or more behavioral responses, wherein the step of altering the presented representational output comprises altering the presented representational output based upon the one or more behavioral responses.

8. The method of claim 7, wherein the one or more behavioral responses comprise a facial expression of the user.

9. The method of claim 7, wherein the one or more behavioral responses comprise a movement of the user.

10. The method of claim 7, wherein the one or more behavioral responses comprises the user's interaction with an input device to the computing system.

11. The method of claim 10, wherein the input device comprises at least one of a keyboard, touch-screen display device, and a mouse.

12. The method of claim 10, wherein the one or more behavioral responses comprise the user's interaction with one or more software applications operating on the computing system.

13. The method of claim 2, wherein the step of altering the presented representational output comprises altering one or more display characteristics of the presented representational output.

14. The method of claim 13, wherein the display characteristics comprise one or more of the size, shape, and intensity of the presented representational output.

15. The method of claim 2, wherein the user's response is one or more physiological responses and behavioral responses, wherein the step of altering the presented representational output comprises altering the presented representational output based upon the one or more physiological responses and behavioral responses.

16. The method of claim 1 further comprising the step of inputting the user's response into a machine learning algorithm configured to detect an anomaly within the computing system using the user's response.

17. The method of claim 16, wherein the machine learning algorithm is further configured to detect an anomaly within the computing system additionally using the measured one or more hidden states internal to the computing system.

18. A method comprising the steps of:
measuring one or more hidden states internal to a computing system related only to a user's active task with the computing system;
using one or more deterministic mapping functions to directly map, without interpretation of the hidden states as being benign or malicious, the measurements to a representational output;
presenting the representational output in real-time and peripheral to the user's active task with the computing system, wherein the presented representational output does not label information pertaining to the hidden states;
determining the user's behavioral responses and physiological responses to the presented representational output; and
altering one or more display characteristics of the presented representational output based upon one or more behavioral responses and physiological responses.

19. A method comprising the steps of:
for more than one computing systems each having a separate user, measuring one or more hidden states internal to each computing system related only to a particular user's active task with the particular computing system;
using one or more deterministic mapping functions to directly map, without interpretation of the hidden states as being benign or malicious, the measurements to a representational output;
presenting the representational output in real-time and peripheral to the particular user's active task with the particular computing system, wherein the presented representational output does not label information pertaining to the hidden states;
determining the particular user's response to the presented representational output; and
for each computing system, inputting the particular user's response into a machine learning algorithm configured to detect an anomaly within the more than one computing systems using the all of the particular users' responses.

20. The method of claim 19, wherein the machine learning algorithm is further configured to detect an anomaly within the more than one computing systems additionally using the measured one or more hidden states internal to each particular computing system.
